(19) United States
(12) Patent Application Publication
(10) Pub. No.: US 2008/0277181 A1
(43) Pub. Date: Nov. 13, 2008

(54) TWO PERSON MOTORCYCLE FRAME

(76) Inventors: Kevin R. Alsop, Big Bear, CA (US); Keith Garcia, Hamford, CA (US); Matthew R. Monroe, Moreno Valley, CA (US)

Correspondence Address: CHRISTIE, PARKER & HALE, LLP, PO BOX 7068, PASADENA, CA, 91109-7068, US

(21) Appl. No.: 11/747,872

(22) Filed: May 11, 2007

(51) Int. Cl. B62K 19/00

(52) U.S. Cl. 180/219

(57) ABSTRACT

A motorcycle frame having a rider seating surface and a passenger seating surface positioned below a top surface of a rear wheel, above a rear wheel axle and forward of the rear wheel.

### FIELD OF THE INVENTION

The present invention is directed to a motorcycle frame and, more particularly to a two seat motorcycle frame that enables a passenger to be seated behind a driver in a position on the frame which is in front of a rear wheel and below a rear wheel fender.

### BACKGROUND OF THE INVENTION

Motorcycle frames were originally designed to accommodate the operator of the motorcycle. The frame was designed such that the rider was positioned directly in front of the rear wheel and typically below the height of the rear fender. Over time it became desirable for a motorcycle to accommodate a passenger in addition to the rider. This was accomplished by incorporating a second seat behind the rider and on top of the rear fender. This seating position for the passenger was above the rear wheel of the motorcycle which moved the center of gravity of the vehicle upwards and rearwards as opposed to a single rider design. A disadvantage of this design is that because the weight of the passenger is elevated and rearward, the motorcycle is less stable and passenger movement affects motorcycle stability negatively with little passenger movement.

Consequently, a need exists for a new motorcycle frame design which can accommodate both the rider and the passenger and provides a stable and safe vehicle which is less affected by passenger movement.

### SUMMARY OF THE INVENTION

The present invention is a novel motorcycle frame design which is long enough to allow both the rider and the passenger to sit below the top surface of the rear fender and in front of the rear wheel. The frame further includes a seat area that allows both the rider and the passenger to sit in front of the rear wheel and lower that the top surface of the rear fender. The frame further provides a wheelbase that is long enough to allow for the seating position of the rider and the passenger plus accommodate an engine, transmission and front and rear suspensions. The frame of the present invention is designed to provide a rake and trail that is engineered for both highway and in-town use and is designed to provide a motorcycle which keeps as much weight as possible between the axles including storage.

### BRIEF SUMMARY OF THE DRAWINGS

FIG. 1 is a side view of a motorcycle frame of the present invention;

FIG. 2 is a perspective view of the motorcycle frame of FIG. 1, including storage compartments; and

FIG. 3 is a side view of the motorcycle frame of FIG. 2.

### DETAILED DESCRIPTION OF THE INVENTION

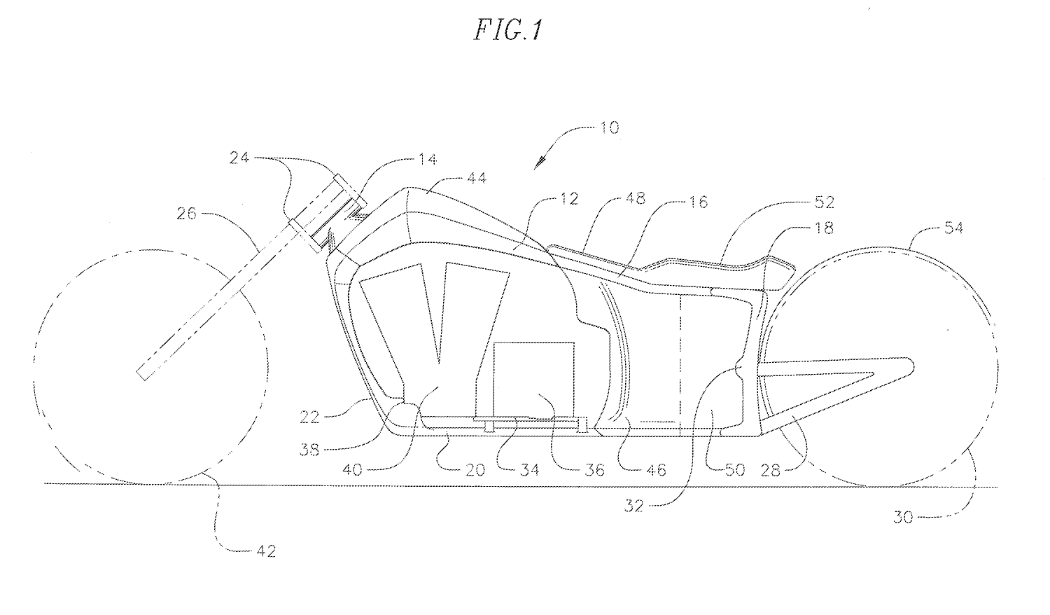

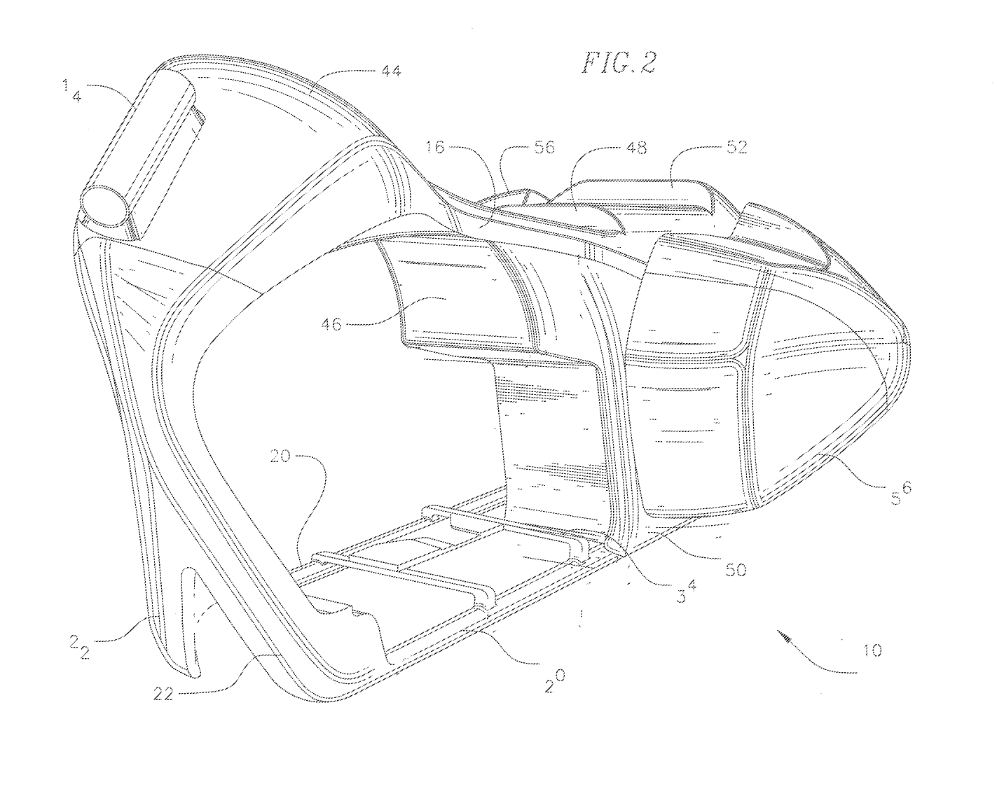

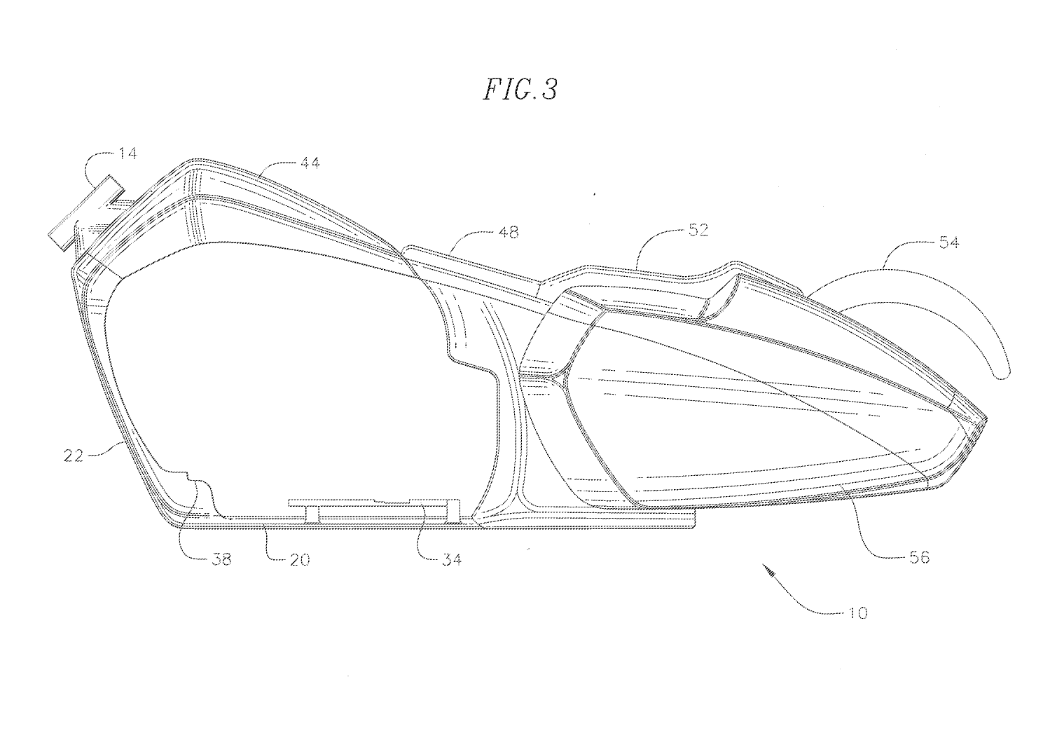

Referring to the drawing FIGS. 1-3 a motorcycle frame 10 of the present invention is illustrated. The frame includes a top tube or backbone 12 positioned between a neck 14 and wishbone tubes 16. The top tube or backbone 12 is welded to the neck 14 and to the wishbone tubes 16. The wishbone tubes 16 are bent to create space for the seating area and are welded to the top tube in the front and to side plates 18 in the rear. Bottom rails 20 of which there are two are welded in the rear to the side plates 18 and to the neck 14 in the front. A vertical portion 22 of bottom rails 20 is also commonly referred to as down tubes. Triple trees 24 are connected to the top tube which in turn hold a front fork 26 to the frame.

A swing arm 28 is positioned at the rear portion of the frame and is used to hold a rear wheel 30 in place. The swing arm 28 is attached to the frame 10 by means of a pivot axle 32 located on the side plates 18. The pivot axle is a solid steel, round stock which fastens to the side plates and provides a pivot point for the swing arm. A suspension system (not shown) is bolted between the frame and the swing arm and is used to cushion and limit the movement of the swing arm.

A transmission plate 34 is welded to the bottom rails 20. The transmission plate is a machined steel plate to which the transmission 36 is bolted. A motor mounting plate 38 extends between the bottom rails for attachment of a motor 40. A front wheel 42 is attached to the frame by front fork 26. A first gas tank 44 is positioned on the top tube 12 and a second enlarged gas tank 46 is positioned between the wishbone tubes 16 and the bottom rails 20 below a rider's seat 48. Rider's seat 48 is positioned on top of the wishbone tubes 16. An oil tank 50 similarly is positioned between the wishbone tubes 16 and the bottom rails 20 below passenger seat 52. Passenger seat 52 is also positioned on wishbone tubes 16 behind rider's seat 48.

A rear fender 54 extends over at least the upper portion of rear tire 30 and is attached to the swingarm. Storage compartments 56 are attached to the rear portion of either side of the frame.

The frame 10 of the present invention enables a passenger to be seated behind the driver in a position on the frame which is in front of the rear wheel and below the top surface of the rear wheel fender. The frame portions, including the bottom rails, top tube or backbone and wishbone tubes are long enough to allow both the rider and the passenger to sit below the top of the rear fender and in front of the rear wheel. The seating area allows both the rider and the passenger to sit in front of the rear wheel and lower than the top of the rear fender. The wheelbase of the frame is long enough to allow for the seating positions of the rider and the passenger plus provide for an engine, transmission, auxiliary fuel tank and oil tank. The frame has been designed to keep as much weight as possible between the wheel axles including additional weight in the storage compartments. By moving the position of the passenger in front of the rear wheel and both the rider and the passenger forward in the frame, more weight is in the center of the motorcycle to produce better handling and comfort.

### EXAMPLE

An exemplary configuration motorcycle frame of the present invention includes a 10″ minimum from the transmission to the start of the rear wheel. The frame provides for a 24 inch or lower seat height with the passenger positioned in front of the rear wheel. Total rack of the frame must be more than 30 degrees and the wheelbase should be no shorter than 70 inches. The rider and the passenger seat height is no higher than the top of the rear fender.

Although the present invention has been described and illustrated with respect to a preferred embodiment thereof, it is to be understood that changes and modifications can be made therein which are within the full intended scope of the invention as hereinafter claimed.

What is claimed is:

1. A motorcycle frame having a rider seating surface and a passenger seating surface both positioned below a top surface of a rear wheel, above a rear wheel axle and forward of the rear wheel.

2. The frame of claim 1 wherein the frame further includes a rear wheel fender.

3. The frame of claim 2 wherein the rider seating surface and the passenger seating surface is below a top surface of the rear wheel fender.

4. The frame of claim 1 further including a gas tank positioned below at least one of the rider seating surface or the passenger seating surface.

5. The frame of claim 1 further including an oil tank positioned below at least one of the rider seating surface of the passenger seating surface.

6. The frame of claim 1 further including storage compartments attached to the frame.

7. A motorcycle comprising:
a frame;
a rear fender adjacent to the frame;
a two-person seat positioned on the frame;
a gas tank positioned below the seat; and
a front wheel and a rear wheel attached to the frame,
wherein the two-person seat has a seating surface that is below a top surface of the rear fender and in front of the rear wheel.

8. The motorcycle of claim 7 further comprising an oil tank positioned below the seat.

9. The motorcycle of claim 7 further including at least one storage compartment attached to the frame.

10. An elongated motorcycle frame having means to provide a seating surface for a rider and a passenger between a front and rear wheel attached to the frame and below a top surface of the rear wheel and above an axle of the rear wheel.

11. The motorcycle frame of claim 10 further comprising a gas tank positioned below the means to provide a seating surface.

12. The frame of claim 10 further comprising an oil tank positioned below the means to provide a seating surface.

13. The frame of claim 10 further comprising at least one storage compartment attached to the frame.
